(19) United States
(12) Patent Application Publication
(10) Pub. No.: US 2023/0202134 A1
(43) Pub. Date: Jun. 29, 2023

(54) GYMNASTIC APPARATUS FORCE BEARING FRAME AND FIBER STRUCTURE

(71) Applicant: Shandong Taishan Sports Equipment Co., Ltd., Dezhou City (CN)

(72) Inventors: Gang CUI, Dezhou City (CN); Wei Zhang, Dezhou City (CN); Desen Xu, Dezhou City (CN); Changrong Pan, Dezhou City (CN); Wei Wang, Dezhou City (CN); He Wang, Dezhou City (CN); Wenhao Zhang, Dezhou City (CN); Hao Chen, Dezhou City (CN)

(21) Appl. No.: 17/678,541

(22) Filed: Feb. 23, 2022

(30) Foreign Application Priority Data
Dec. 24, 2021 (CN) 202111601810.9

(51) Int. Cl. B32B 5/26; B32B 5/12; B32B 5/02; B32B 1/08; B29C 70/22

(52) U.S. Cl. CPC B32B 5/263; B29C 70/222; B32B 1/08; B32B 5/12; B32B 5/024; B29L 2031/52; B32B 2262/106; B32B 2597/00

(57) ABSTRACT

The present disclosure discloses a fiber structure, including a plurality of fiber layers. The plurality of the fiber layers are stacked and arranged in a surrounding manner and are impregnated and cured in sequence. The fiber structure of the present disclosure is high in structural strength and low in mass. The present disclosure further provides a gymnastic apparatus force bearing frame, including the above-mentioned fiber structure, which is beneficial to reducing the weight of the gymnastic apparatus force bearing frame, facilitating the movement, transportation, disassembling, and assembling of the apparatus, and reducing the labor burden of an operator.

### CROSS REFERENCE TO RELATED APPLICATION(S)

This patent application claims the benefit and priority of Chinese Patent Application No. 202111601810.9, filed on Dec. 24, 2021, the disclosure of which is incorporated by reference herein in its entirety as part of the present application.

### TECHNICAL FIELD

The present disclosure relates to the technical field of gymnastic apparatuses, and in particular, to a gymnastic apparatus force bearing frame and a fiber structure.

### BACKGROUND ART

At present, support frames of gymnastic apparatuses in sporting equipment, such as horizontal bars, parallel bars, uneven bars, vaulting table, pommel horses, balance beams, and rings, are made of metal material components, so that the weight of the apparatuses is large, which is not beneficial to the transportation, movement, or installation of the apparatuses.

Therefore, how to reduce the weight of the sporting equipment to facilitate transportation and installation is an urgent problem to be solved by those skilled in the art.

### SUMMARY

An objective of the present disclosure is to provide a gymnastic apparatus force bearing frame and a fiber structure, so as to reduce the weight of a gymnastic apparatus and facilitate transportation and installation.

To achieve the above-mentioned objective, the present disclosure provides the following solution. The present disclosure provides a fiber structure, including a plurality of fiber layers. The plurality of the fiber layers are stacked and arranged in a surrounding manner and are impregnated and cured in sequence.

Preferably, a woven fabric layer is cured on one side, far away from a centroid of the fiber structure, of the fiber layer.

The fiber layer is made of one or more of the following substances: a carbon fiber layer, a glass fiber layer, a basalt fiber layer, an aramid fiber layer, flax fibers, and ultra-high molecular weight polyethylene fibers.

Preferably, in a direction away from the centroid of the fiber structure to close to the centroid of the fiber structure, the fiber structure includes a first carbon fiber stacking layer, a first carbon fiber cross stacking layer, and a second carbon fiber stacking layer that are impregnated and cured in sequence.

The first carbon fiber stacking layer is formed by stacking adjacent unidirectional carbon fiber sheets in a crossed manner within the range of 0° to 90°, and the woven fabric layer is cured on one side, far away from the centroid of the fiber structure, of the first carbon fiber stacking layer.

Adjacent unidirectional carbon fiber sheets at a top layer of the first carbon fiber cross stacking layer are formed by stacking within the range of 90° to 180°, and adjacent unidirectional carbon fiber sheets at a bottom layer of the first carbon fiber cross stacking layer are formed by stacking within the range of 0° to 90°.

The second carbon fiber stacking layer is formed by stacking adjacent unidirectional carbon fiber sheets in a crossed manner within the range of 0° to 90°.

The unidirectional carbon fiber sheets of the first carbon fiber stacking layer, the first carbon fiber cross stacking layer, and the second carbon fiber stacking layer are all laid in a manner of rotating corresponding angles in the same direction.

Preferably, the fiber structure further includes a steel reinforcement body layer. The steel reinforcement body layer is cured between the first carbon fiber cross stacking layer and the first carbon fiber stacking layer; or, the steel reinforcement body layer is cured on one side, far away from the first carbon fiber cross stacking layer, of the second carbon fiber stacking layer.

Preferably, both the first carbon fiber stacking layer and the second carbon fiber stacking layer are of ring-shaped structures. The steel reinforcement body layer is arranged between the first carbon fiber stacking layer and the second carbon fiber stacking layer. The steel reinforcement body layer is connected to the first carbon fiber cross stacking layer to form a ring-shaped structure.

Preferably, the first carbon fiber stacking layer, the first carbon fiber cross stacking layer, and the second carbon fiber stacking layer are all non-closed structures. An opening is formed at the same position of the first carbon fiber stacking layer, the first carbon fiber cross stacking layer, and the second carbon fiber stacking layer.

Preferably, an inner woven fabric layer is cured on one side, close to the centroid of the fiber structure, of the fiber layer.

Preferably, the woven fabric layer is formed by weaving an interlaced textile material of thermoplastic wires. The fiber layer and the woven fabric layer can be cured through compression molding, pultrusion molding, vacuumizing molding, or vacuum resin introduction molding.

The present disclosure further provides a gymnastic apparatus force bearing frame, including the above-mentioned fiber structure.

Preferably, the fiber structure is an upright post, a supporting leg, and/or a cross beam.

Compared with the prior art, the present disclosure achieves the following technical effects: the fiber structure of the present disclosure includes a plurality of fiber layers, and the plurality of the fiber layers are stacked and arranged in a surrounding manner and are impregnated and cured in sequence. The fiber structure of the present disclosure is high in structural strength and low in mass. The present disclosure further provides a gymnastic apparatus force bearing frame, including the above-mentioned fiber structure, which is beneficial to reducing the weight of the gymnastic apparatus force bearing frame, facilitating the movement, transportation, disassembling, and assembling of the apparatus, and reducing the labor burden of an operator.

### BRIEF DESCRIPTION OF THE DRAWINGS

To describe the technical solutions in the embodiments of the present disclosure or in the prior art more clearly, the following briefly describes the accompanying drawings required for describing the embodiments. Apparently, the accompanying drawings in the following description are merely some embodiments of the present disclosure, and those of ordinary skill in the art may still derive other drawings from these accompanying drawings without creative efforts.

FIG. 1 is a schematic diagram of a cross section of a fiber structure of the present disclosure.

FIG. 2 is a schematic diagram of a cross section of a fiber structure in an embodiment of the present disclosure.

FIG. 3 is a schematic diagram of a cross section of a fiber structure in other embodiments of the present disclosure.

FIG. 4 is a schematic diagram of a gymnastic apparatus force bearing frame of the present disclosure.

Reference signs in the drawings: 1-woven fabric layer, 2-first carbon fiber stacking layer, 3-first carbon fiber cross stacking layer, 4-second carbon fiber stacking layer, 5-steel reinforcement body layer, and 6-inner woven fabric layer.

### DETAILED DESCRIPTION OF THE EMBODIMENTS

Technical solutions in the embodiments of the present disclosure will be clearly and completely described herein below with reference to the drawings in the embodiments of the present disclosure. Apparently, the described embodiments are merely part rather than all of the embodiments of the present disclosure. On the basis of the embodiments of the present disclosure, all other embodiments obtained by those of ordinary skill in the art without creative work fall within the scope of protection of the present disclosure.

An objective of the present disclosure is to provide a gymnastic apparatus force bearing frame and a fiber structure, so as to reduce the weight of a gymnastic apparatus and facilitate transportation and installation.

In order to make the abovementioned objective, features, and advantages of the present disclosure more apparent and more comprehensible, the present disclosure is further described in detail below with reference to the drawings and specific implementation manners.

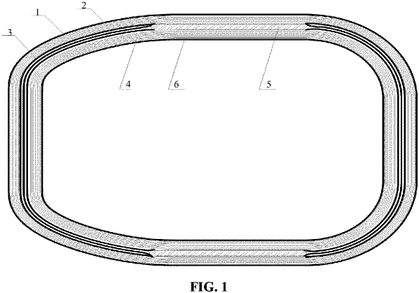

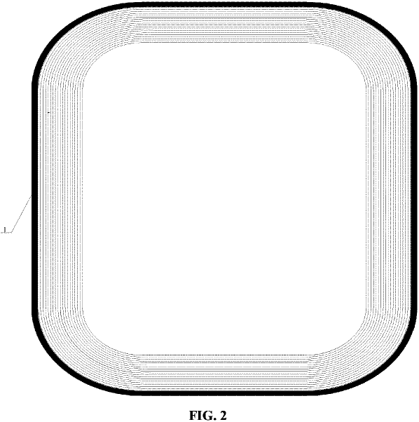

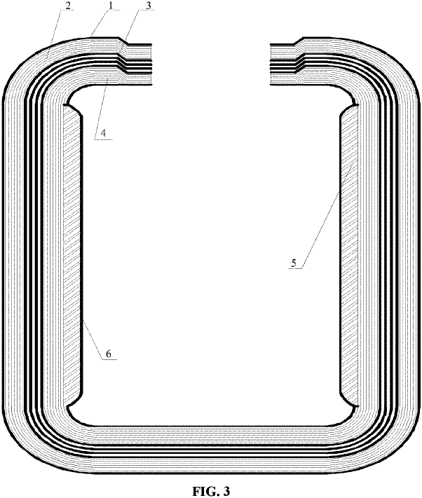

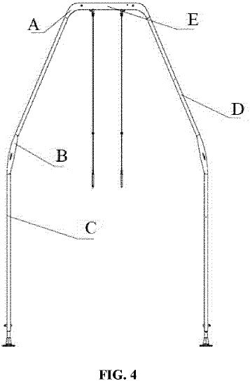

Referring to FIG. 1 to FIG. 4, FIG. 1 is a schematic diagram of a cross section of a fiber structure of the present disclosure; FIG. 2 is a schematic diagram of a cross section of a fiber structure in an embodiment of the present disclosure; FIG. 3 is a schematic diagram of a cross section of a fiber structure in other embodiments of the present disclosure; and FIG. 4 is a schematic diagram of a gymnastic apparatus force bearing frame of the present disclosure.

The present disclosure provides a fiber structure, including a plurality of fiber layers. The plurality of the fiber layers are stacked and arranged in a surrounding manner and are impregnated and cured in sequence.

The fiber structure of the present disclosure is formed by laminating, surrounding, and curing in sequence, and is high in structural strength, and low in mass. It should be explained that the plurality of fiber layers are impregnated and cured by using high polymers.

A woven fabric layer 1 is cured on one side, far away from a centroid of the fiber structure, of the fiber layer. The woven fabric layer 1 can provide protection for the fiber layer, prolong the service life of the fiber structure, and meanwhile, improve and enhance the attractiveness of the fiber structure. Meanwhile, the fiber layer is made of one or more of the following substances: a carbon fiber layer, a glass fiber layer, a basalt fiber layer, an aramid fiber layer, flax fibers, and ultra-high molecular weight polyethylene fibers. In practical production, a certain type of fiber or different types of fibers can be selected for performing combined preparation according to specific working conditions to meet different use requirements. In the specific implementation manner, according to the fiber structure, a carbon fiber unidirectional prepreg is stacked and surrounded in sequence to form a base layer, and the woven fabric layer 1 is cured on an outer side of the base layer, so as to form a carbon fiber composite material. The weight of the material is light; and for the fiber layer of a base, the same or different materials may be selected for stacking according to actual requirements. The prepreg involved in the present disclosure is a composition of a resin matrix and a reinforcement body prepared by impregnating continuous fibers or fabrics by using the resin matrix under strictly controlled conditions, and a specific process is not limited.

More specifically, in a direction far away from the centroid of the fiber structure to close the centroid of the fiber structure, the fiber structure includes a carbon fiber stacking layer 2, a first carbon fiber cross stacking layer 3, and a second carbon fiber stacking layer 4 that are impregnated and cured in sequence. The first carbon fiber stacking layer 2 is formed by stacking adjacent unidirectional carbon fiber sheets in a crossed manner within the range of 0° to 90°, and the woven fabric layer is cured on one side, far away from the centroid of the fiber structure, of the first carbon fiber stacking layer. Adjacent unidirectional carbon fiber sheets at a top layer (i.e., on one side close to the first carbon fiber stacking layer 2) of the first carbon fiber cross stacking layer 3 are formed by stacking within the range of 90° to 180°, and adjacent unidirectional carbon fiber sheets at a bottom layer (i.e., on one side close to the first carbon fiber stacking layer 2) of the first carbon fiber cross stacking layer 3 are formed by stacking within the range of 0° to 90°. The second carbon fiber stacking layer 4 is formed by stacking adjacent unidirectional carbon fiber sheets in a crossed manner within the range of 0° to 90°. The unidirectional carbon fiber sheets of the first carbon fiber stacking layer 2, the first carbon fiber cross stacking layer 3, and the second carbon fiber stacking layer 4 are all laid in a manner of rotating corresponding angles in the same direction.

The unidirectional carbon fiber sheets of the first carbon fiber stacking layer 2, the first carbon fiber cross stacking layer 3, and the second carbon fiber stacking layer 4 are respectively formed by deflecting and laying the unidirectional carbon fiber sheets layer by layer in a staggered manner within a certain angle range. The deflecting directions of the unidirectional carbon fiber sheets of the first carbon fiber stacking layer 2 and the second carbon fiber stacking layer 4 are opposite to each other. In addition, in the first carbon fiber cross stacking layer 3 between the first carbon fiber stacking layer 2 and the second carbon fiber stacking layer 4, the deflecting direction of the unidirectional carbon fiber sheets close to the first carbon fiber stacking layer 2 is opposite to the deflecting direction of the unidirectional carbon fiber sheets of the first carbon fiber stacking layer 2, and the deflecting direction of the unidirectional carbon fiber sheets close to the second carbon fiber stacking layer 4 is opposite to the deflecting direction of the unidirectional carbon fiber sheets of the second carbon fiber stacking layer 4, which realizes the lightweight of the fiber structure, and meanwhile, enhances the structural strength of the fiber structure. In addition, during laying the first carbon fiber stacking layer 2, the first carbon fiber cross stacking layer 3, and the second carbon fiber stacking layer 4, the unidirectional carbon fiber sheets may be laid layer by layer after being rotated at corresponding angles around the same direction within respective deflection range angles of the base layer (i.e., the unidirectional carbon fiber sheet laid first), and the laying process is not limited.

In other specific implementation manners of the present disclosure, the fiber structure may also be one of the first carbon fiber stacking layer 2, the first carbon fiber cross stacking layer 3, and the second carbon fiber stacking layer 4.

The present specific implementation manner discloses a specific form of the carbon fiber unidirectional prepreg. In practice, a crossing angle of the unidirectional carbon fiber sheets is set according to the requirement for strength, and the arrangement order and the like of the first carbon fiber stacking layer 2, the second carbon fiber stacking layer 4 and the first carbon fiber cross stacking layer 3 can all be set according to different requirements, as long as the fiber structure stacked, surrounded, and cured by using the carbon fiber unidirectional prepreg is within the scope of protection.

Further, the fiber structure further includes a steel reinforcement body layer 5. The steel reinforcement body layer 5 further improves the structural strength of the fiber structure, which is beneficial to improving the adaptability of the fiber structure. The steel reinforcement body layer 5 may be cured between the first carbon fiber cross stacking layer 3 and the second carbon fiber stacking layer 4. In other specific implementation manners of the present disclosure, the steel reinforcement body layer 5 may also be cured on one side, far away from the first carbon fiber cross stacking layer 3, of the second carbon fiber stacking layer 4. The steel reinforcement body layer 5, as a reinforcement layer, is selectively set. The set position is flexible, and the set number and the set position of the steel reinforcement body layer 5 are selected according to specific structure or strength requirements.

In the present specific implementation manner, both the first carbon fiber stacking layer 2 and the second carbon fiber stacking layer 4 are of ring-shaped structures. The steel reinforcement body layer 5 is arranged between the first carbon fiber stacking layer 2 and the second carbon fiber stacking layer 4, and the steel reinforcement body layer 5 is connected to the first carbon fiber cross stacking layer 3 to form a ring-shaped structure. Two groups of steel reinforcement body layers 5 are arranged symmetrically by taking a central line of the ring-shaped structure as an axis, which cannot only improve the structural strength of the fiber structure, but also improve the stress uniformity of the fiber structure. The number and positions of the steel reinforcement body layers 5 can be determined according to specific working conditions of fiber structure in practical application, so as to meet the requirement for strength in different practical use conditions.

In other specific implementation manners of the present disclosure, the first carbon fiber stacking layer 2, the first carbon fiber cross stacking layer 3, and the second carbon fiber stacking layer 4 are all of non-closed structures. An opening is formed at the same position of the first carbon fiber stacking layer 2, the first carbon fiber cross stacking layer 3, and the second carbon fiber stacking layer 4, i.e., an opening is formed in the cross section of the fiber structure. At this time, if the steel reinforcement body layer 5 is arranged on one side, far away from the first carbon fiber cross stacking layer 3, of the second carbon fiber stacking layer 4, and is used as an inner reinforcement layer of the fiber structure. The fiber structure in this arrangement manner can be used to manufacture a cross beam of a ring frame or a cross beam of a vaulting table frame, and the steel reinforcement body layer 5 may also be connected to the first carbon fiber stacking layer 2 or the second carbon fiber stacking layer 4 to form a structure with a required shape.

In addition, the inner woven fabric layer 6 is cured on one side, close to the centroid of the fiber structure, of the fiber layer. The inner woven fabric layer 6 is arranged, which improves the quality of an inner surface of the fiber structure, further improves the structural integrity and the attractiveness of the fiber structure, and meanwhile, improves the tear resistance of the fiber structure. Here, it should be explained that the woven fabric layer 1 and the inner woven fabric layer 6 respectively include an intermediate woven fabric layer, an inner woven fabric layer, and a woven fabric layer, which may be 3KP woven fabric or other types of woven fabrics.

In addition, both the woven fabric layer 1 and the inner woven fabric layer 6 may be formed by weaving an interlaced textile material of thermoplastic wires. The interlaced textile material is a fabric or a woven fabric obtained by interlacing textile fibers. The interlaced textile material may include the thermoplastic wires. The fiber layer and the woven fabric layer 1 can be cured through compression molding, pultrusion molding, vacuumizing molding, or vacuum resin introduction molding. A thermoplastic material may be mixed with warp yarns, so that the interlaced textile material can be kept at a proper position during pultrusion molding.

Meanwhile, the present disclosure further provides a gymnastic apparatus force bearing frame, including the above-mentioned fiber structure. The gymnastic apparatus force bearing frame is manufactured by using the fiber structure, which reduces the mass of the gymnastic apparatus force bearing frame while ensuring the structural strength of the gymnastic apparatus force bearing frame.

Furthermore, the shape of the cross section of the fiber structure may be of a ring-shaped or non-closed structure. The ring-shaped structure may be a square ring, a circular ring, or the like. The fiber structure may be used for an upright post, a supporting leg, and/or a cross section. Since some structures in gymnastic apparatuses need to be installed with other structures, for example, auxiliary parts need to be connected to cross beams of frame main bodies of rings, vaulting tables, and the like. The cross beams are of ring-shaped structures with openings. Therefore, the cross section of the fiber structure can be of a non-closed structure. Specifically, an opening is formed at the same position of the first carbon fiber stacking layer 2, the first carbon fiber cross stacking layer 3, and the second carbon fiber stacking layer 4. Those skilled in the art can understand that the shape of the cross section of a frame main body may be arranged according to different requirements. The first carbon fiber stacking layer 2, the first carbon fiber cross stacking layer 3, and the second carbon fiber stacking layer 4 may be cured according to the required shape of the frame main body.

In practice, the gymnastic apparatus force bearing frame may be a force bearing frame body of any gymnastic apparatus. Taking a ring as an example, the force bearing frame body of the ring is usually of a structure formed by connecting a plurality of sections of straight lines, as shown in FIG. 4. Material structures of part A and part B of the ring may be as shown in FIG. 1, material structures of part C and part D are as shown in FIG. 2, and a material structure of part E is as shown in FIG. 3. Structures of the part A and part B of the ring are the same, and the materials from the outside to the inside are as follows in sequence: the woven fabric layer 1, the first carbon fiber stacking layer 2, the first carbon fiber cross stacking layer 3, the second carbon fiber stacking layer 4, and the inner woven fabric layer 6. The first carbon fiber cross stacking layer 3 and the steel reinforcement body layer 5 are connected into a ring. The position of the steel reinforcement body layer 5 may be set according to different requirements. Preferably, two steel reinforcement body layers are arranged and are arranged oppositely. The structures of part C and part D of the ring are the same, and the materials from the outside to the inside are as follows in sequence: the woven fabric layer 1 on an outer side, the first carbon fiber stacking layer 2, the first carbon fiber cross stacking layer 3, or the second carbon fiber stacking layer 4 located in the middle, and an inner woven fabric layer 6 located on the inner side. The structure materials of part E of the ring are as follows in sequence: the woven fabric layer 1, the first carbon fiber stacking layer 2, the first carbon fiber cross stacking layer 3, the second carbon fiber stacking layer 4, and the inner woven fabric layer 6. The structure of part E is provided with an opening, so as to connect other parts of the gymnastic apparatus, such as a ring rope.

The fiber structure of the present disclosure is high in structural strength and low in mass. The gymnastic apparatus force bearing frame manufactured by the fiber structure is convenient to transfer, transport, disassemble, and assemble.

In the present disclosure, specific examples are applied to illustrate the principle and implementation manner of the present disclosure. The description of the above embodiment is only used to help understand the method and core idea of the present disclosure. Meanwhile, for those of ordinary skill in the art, there will be changes in the specific implementation manner and scope of application according to the idea of the present disclosure. In conclusion, the content of the present description shall not be construed as a limitation to the present disclosure.

What is claimed is:

1. A fiber structure, comprising: a plurality of fiber layers, wherein the plurality of the fiber layers are stacked and arranged in a surrounding manner and are impregnated and cured in sequence.

2. The fiber structure according to claim 1, wherein a woven fabric layer (1) is cured on one side, far away from a centroid of the fiber structure, of the fiber layer; and
the fiber layer is made of one or more of the following substances: a carbon fiber layer, a glass fiber layer, a basalt fiber layer, an aramid fiber layer, flax fibers, and ultra-high molecular weight polyethylene fibers.

3. The fiber structure according to claim 2, wherein in a direction away from the centroid of the fiber structure to close to the centroid of the fiber structure, the fiber structure comprises the following layers that are impregnated and cured in sequence:
a first carbon fiber stacking layer (2), the first carbon fiber stacking layer (2) being formed by stacking adjacent unidirectional carbon fiber sheets in a crossed manner within the range of 0° to 90°, and the woven fabric layer (1) being cured on one side, far away from the centroid of the fiber structure, of the first carbon fiber stacking layer (2);
a first carbon fiber cross stacking layer (3), adjacent unidirectional carbon fiber sheets at a top layer of the first carbon fiber cross stacking layer (3) being formed by stacking within the range of 90° to 180°, and adjacent unidirectional carbon fiber sheets at a bottom layer of the first carbon fiber cross stacking layer (3) being formed by stacking within the range of 0° to 90°; and
a second carbon fiber stacking layer (4), the second carbon fiber stacking layer (4) being formed by stacking adjacent unidirectional carbon fiber sheets in a crossed manner within the range of 0° to 90°, wherein
the unidirectional carbon fiber sheets of the first carbon fiber stacking layer (2), the first carbon fiber cross stacking layer (3), and the second carbon fiber stacking layer (4) are all laid in a manner of rotating corresponding angles in the same direction.

4. The fiber structure according to claim 3, further comprising a steel reinforcement body layer (5), wherein the steel reinforcement body layer (5) is cured between the first carbon fiber cross stacking layer (3) and the first carbon fiber stacking layer (4); or the steel reinforcement body layer (5) is cured on one side, far away from the first carbon fiber cross stacking layer (3), of the second carbon fiber stacking layer (4).

5. The fiber structure according to claim 3, wherein both the first carbon fiber stacking layer (2) and the second carbon fiber stacking layer (4) are of ring-shaped structures; the steel reinforcement body layer (5) is arranged between the first carbon fiber stacking layer (2) and the second carbon fiber stacking layer (4); and the steel reinforcement body layer (5) is connected to the first carbon fiber cross stacking layer (3) to form a ring-shaped structure.

6. The fiber structure according to claim 3, wherein the first carbon fiber stacking layer (2), the first carbon fiber cross stacking layer (3), and the second carbon fiber stacking layer (4) are all non-closed structures; and an opening is formed at the same position of the first carbon fiber stacking layer (2), the first carbon fiber cross stacking layer (3), and the second carbon fiber stacking layer (4).

7. The fiber structure according to claim 1, wherein an inner woven fabric layer (6) is cured on one side, close to the centroid of the fiber structure, of the fiber layer.

8. The fiber structure according to claim 2, wherein an inner woven fabric layer (6) is cured on one side, close to the centroid of the fiber structure, of the fiber layer.

9. The fiber structure according to claim 3, wherein an inner woven fabric layer (6) is cured on one side, close to the centroid of the fiber structure, of the fiber layer.

10. The fiber structure according to claim 4, wherein an inner woven fabric layer (6) is cured on one side, close to the centroid of the fiber structure, of the fiber layer.

11. The fiber structure according to claim 5, wherein an inner woven fabric layer (6) is cured on one side, close to the centroid of the fiber structure, of the fiber layer.

12. The fiber structure according to claim 6, wherein an inner woven fabric layer (6) is cured on one side, close to the centroid of the fiber structure, of the fiber layer.

13. The fiber structure according to claim 1, wherein the woven fabric layer (1) is formed by weaving an interlaced textile material of thermoplastic wires; and the fiber layer and the woven fabric layer (1) can be cured through compression molding, pultrusion molding, vacuumizing molding, or vacuum resin introduction molding.

14. The fiber structure according to claim 2, wherein the woven fabric layer (1) is formed by weaving an interlaced textile material of thermoplastic wires; and the fiber layer and the woven fabric layer (1) can be cured through compression molding, pultrusion molding, vacuumizing molding, or vacuum resin introduction molding.

15. The fiber structure according to claim 3, wherein the woven fabric layer (1) is formed by weaving an interlaced textile material of thermoplastic wires; and the fiber layer and the woven fabric layer (1) can be cured through compression molding, pultrusion molding, vacuumizing molding, or vacuum resin introduction molding.

16. The fiber structure according to claim 4, wherein the woven fabric layer (1) is formed by weaving an interlaced textile material of thermoplastic wires; and the fiber layer and the woven fabric layer (1) can be cured through compression molding, pultrusion molding, vacuumizing molding, or vacuum resin introduction molding.

17. The fiber structure according to claim 5, wherein the woven fabric layer (1) is formed by weaving an interlaced textile material of thermoplastic wires; and the fiber layer and the woven fabric layer (1) can be cured through compression molding, pultrusion molding, vacuumizing molding, or vacuum resin introduction molding.

18. The fiber structure according to claim 6, wherein the woven fabric layer (1) is formed by weaving an interlaced textile material of thermoplastic wires; and the fiber layer and the woven fabric layer (1) can be cured through compression molding, pultrusion molding, vacuumizing molding, or vacuum resin introduction molding.

19. A gymnastic apparatus force bearing frame, comprising the fiber structure according to claim 1.

20. The gymnastic apparatus force bearing frame according to claim 19, wherein the fiber structure is an upright post, a supporting leg, and/or a cross beam.
